(19) United States
(12) Patent Application Publication
(10) Pub. No.: US 2012/0015074 A1
(43) Pub. Date: Jan. 19, 2012

(54) DRIED MEAT SNACK AND PROCESS OF PREPARATION THEREOF

(76) Inventor: Andrew Draganski, Highland Park, NJ (US)

(21) Appl. No.: 13/184,177

(22) Filed: Jul. 15, 2011

Related U.S. Application Data
(60) Provisional application No. 61/364,894, filed on Jul. 16, 2010.

(51) Int. Cl. A23L 1/317; A23L 1/314; A23L 1/212; A23L 1/36; A23L 1/325; A23P 1/00; A23L 1/318

(52) U.S. Cl. 426/59; 426/272; 426/92

(57) ABSTRACT

Disclosed herein is a process for making a dried meat snack and the product produced by said process.

### CROSS-REFERENCE TO RELATED APPLICATIONS

The present application claims the benefit of U.S. Provisional Patent Application No. 61/364,894, filed Jul. 16, 2010, the entire disclosure of which is incorporated by reference herein.

### FIELD OF THE INVENTION

The present invention relates to food products and to their methods of preparation. Specifically, the present invention relates to a process for preparing a dried meat snack and the product produced by the process.

### BACKGROUND OF THE INVENTION

There is a well-known trend in consumer preferences epitomized by a nutritional approach that prescribes a decreased consumption of high glycemic-index carbohydrates with increased consumption of lean protein sources. Due to this trend dried meat-snacks boasting enormous protein content with minimal fat, such as beef-jerky, have enjoyed a recent spike in popularity. Unfortunately for meat snack marketers, industry growth peaked during 2004 and leveled off in subsequent years. Mintel, Meat Snacks, February 2007; Chicago: Mintel International Group Ltd.

Ultimately, beef jerky has never received widespread acceptance in today's food market for two basic reasons: 1) a perception of unhealthiness due to high sodium and added preservatives, and 2) a tough texture and often unappealing taste. Mintel, Meat Snacks, May 2009; Chicago: Mintel International Group Ltd. Accordingly, there is an ongoing interest in the development of healthy, shelf-stable, protein rich snacks that are low in sodium and provide a favorable organoleptic response.

### SUMMARY OF THE INVENTION

The food product of the present invention, referred to in the following description as “Ruggets,” is a natural, dried meat snack that fulfills the marketplace need for a healthy, delicious, shelf-stable snack that also provides a favorable mouth-feel and organoleptic response.

In brief, the present invention provides, in one aspect, a method for preparing a dried meat snack comprising the steps of:

a. providing a plurality of meat chunks comprising a first cure mix, wherein the plurality of meat chunks is substantially fibrous;

b. providing a meat paste comprising a second cure mix, said first and second cure mix being the same or different, and wherein the meat paste is not substantially fibrous;

c. combining at least one of nuts, seeds, fruit, the plurality of meat chunks and the meat paste into a predominantly meat blend, wherein the meat paste functions as a binding agent;

d. forming a meat patty from the meat blend; and

e. cooking the meat patty.

In one aspect of the present invention the step of cooking may include the steps of smoking and drying. In yet another aspect, the method of the invention may include a packaging step.

The present invention further provides a method for preparing a dried meat snack comprising the steps of:

a. separating a quantity of meat into a first portion and a second portion;

b. subdividing the first portion into a plurality of meat chunks, wherein the plurality of meat chunks is substantially fibrous;

c. comminuting the second portion into a meat paste, wherein the meat paste is not substantially fibrous;

d. first curing the plurality of meat chunks, wherein first curing comprises applying a first cure mix to the plurality of meat chunks;

e. second curing the meat paste, wherein second curing comprises applying a second cure mix to the meat paste;

f. combining at least one of nuts, seeds, fruit, the plurality of meat chunks and the meat paste into a meat blend, wherein the meat paste functions as a binding agent;

g. forming a meat patty from the meat blend; and

h. cooking the meat patty.

In one aspect of the present invention, the first portion is at least about 40-60 wt. % of the quantity of meat. In another aspect, the second portion is at least about 40-60 wt. % of the quantity of meat.

The present invention also provides products made by the processes set forth hereinabove.

As described hereinbelow, the meat snack of the invention is prepared as an article of manufacture, typically in patty form, which is sealed in a suitable package.

### BRIEF DESCRIPTION OF THE DRAWINGS

FIG. 1 is process flow diagram detailing the organization of steps in a preferred embodiment of the method of the invention for the production of Ruggets.

### DETAILED DESCRIPTION OF THE INVENTION

As previously stated, Ruggets are healthy, shelf-stable, dried meat snacks providing favorable mouth-feel and organoleptic response. The product not only provides a favorable taste and mouth-feel but also interesting textual variation by comprising chunks of meat, comminuted meat, nuts, vegetables, fruit, and whole grains in a single snack. As a natural product, Ruggets are a shelf-stable snack which eliminates the need to add preservatives while also achieving a 25% reduction in sodium compared to similar dried meat products. As exemplified below, a serving size of Ruggets provides high protein, low fat, and fiber. A serving of Ruggets contains approximately 4.5-13.5 g of protein. Preferably, a serving of Ruggets contains about 9 g of protein.

To address undesirable tough and chewy texture found in traditional meat snacks, comminuted meat and cubed meat are blended with dried fruit. The comminuted meat serves to both soften the texture and bind the various ingredient pieces into a cohesive unit. This formulation renders moot the necessity for starch binding agents which would add undesired carbohydrates to the snack. This formulation also allows for “all natural” status since most starch binders contain processed ingredients (e.g., modified starches). The addition of fruit to the snack formulation further provides a moist and chewy texture while helping to maintain an overall low water activity (A_{W}). Water activity is a measure of how efficiently the water present can take part in a chemical or physical reaction. Water activity is defined as A_{w}=p/pₒ, where p and pₒ are the partial pressures of water in the food and pure water under identical conditions, respectively. Water activity control in a food product enables the resistance of spoilage and maintenance of a fresh taste and mouth feel. The water activity of a food, or a food subsystem, is a useful measurement of the degree of “freeness” of water contained in that food. Water activity is determined by the combined effect of moisture in the food as well as the nature of various components dissolved in an aqueous phase of the food. In one embodiment, the A_{w} of the instant invention is about 0.6-0.85. Preferably the A_{w} of the instant invention is less than about 0.75.

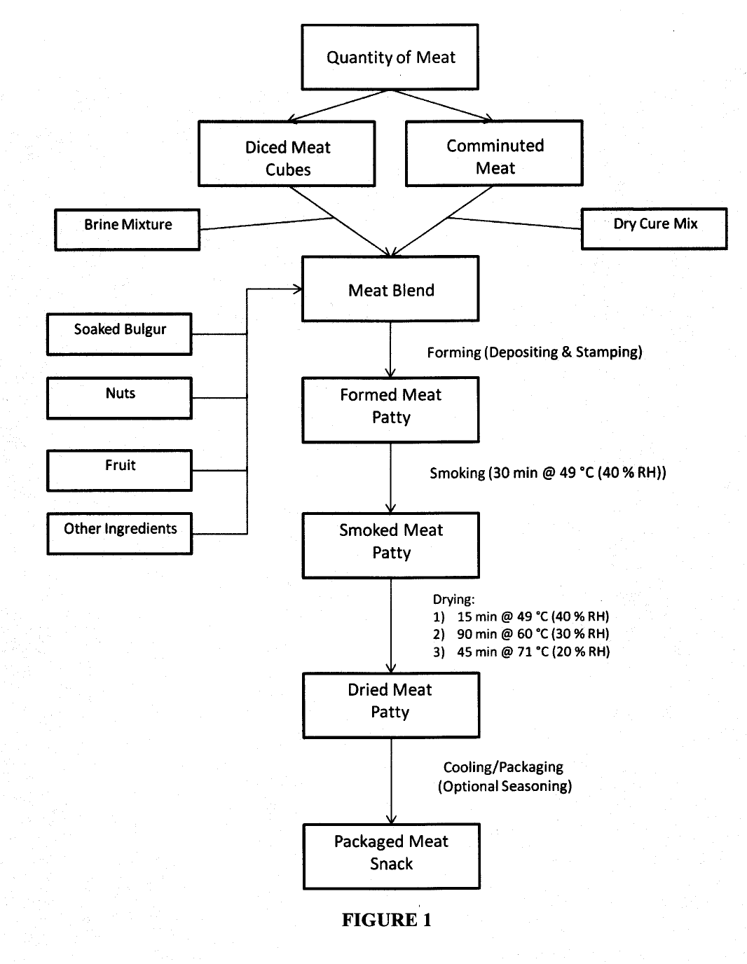

Ruggets may be prepared by a process which comprises the steps of dividing (cutting, dicing, grinding), brining/curing, mixing, forming, smoking, and drying (FIG. 1). In one embodiment, the processing of Ruggets may be performed in a cold room at 4° C. until the forming step at which point the temperature is increased above 4° C. Meat and lactic acid bacteria culture is stored under refrigeration at a temperature of 4° C. Other non-meat ingredients such as cracked-wheat, dried fruits and nuts, and dry cure mix are stored under ambient conditions. The meat may be selected from beef, buffalo, chicken, venison, veal, pork, lamb, fish, shellfish, turkey and vegetable-based meat substitute. In a preferred method of the invention the meat is beef. The cut of beef may be selected from loin and top, bottom and inside round. Most preferably, the meat comprises inside top round, denuded sub-primal beef cuts. The meat substitute may comprise mushrooms, legumes, pulses and soy protein products, including textured vegetable product, tofu (dry tofu and tofu skin), and the like.

Dividing or subdividing refers to the portioning of meat for specific uses in the process of preparing Ruggets, which may involve cutting, dicing and grinding of meat chunks. In the preferred method of the invention a quantity of meat is cut to divide it into separate portions. A first portion (40-60 wt % of the quantity of meat) is diced into smaller discrete units; a second portion (40-60 wt % of the quantity of meat) is comminuted to produce a meat paste.

The first portion of meat is reduced in size to chunks by a dicing machine. The first portion may be diced to provide 0.5 cm per side chunks. As used herein, the term “chunk,” as it pertains to meat, is a unit of meat that possesses a substantially fibrous morphology wherein the meat fibers are considerably long and uncut. Instead of 0.5 cm per side however, the chunks may be cut to 0.3 to 1.25 cm per side. Preferably, the chunks are about 0.5×0.5×0.5 cm. In a preferred embodiment, the chunks are cubed; however, the sides of the chunks may not be of uniform length. In another embodiment, the chunks are strips wherein two of the sides are about 0.3 to 1.25 cm in length. The diced meat chunks (75-95 wt % of the first portion) are combined with a cure mix, comprising a brine mix, (5-25 wt % of the first portion) which brines and cures the diced meat chunks.

Brine mixing comprises the mixing of dry brine ingredients and water to prepare a brine mix. In one embodiment the brine mix comprises water (50-65 wt % of the brine mix), salt (4.5-5.5 wt % of the brine mix), sugar (20-40 wt % of the brine mix), a nitrite source (2-3 wt % of the brine mix), and a brine mix flavoring (3-6 wt % of the brine mix). Salt is an essential ingredient that suppresses microbial survival via reduced water activity. Furthermore, salt effects the release of salt soluble proteins which gel upon cooking and provide essential cohesion of the finished product. In one embodiment of the present invention, the brine mix flavoring is a source of umami. Umami is one of the five tastes and elicits a meaty or savory taste response. The brine mix flavoring may be selected from miso, steak sauce, shrimp paste, Worcestershire sauce, fermented bean paste, anchovy paste, and soy sauce powder. Preferably, the brine mix flavoring is soy sauce powder. The sugar may be selected from white sugar or brown sugar. Preferably, brown sugar is used. Brown sugar is a less refined sugar that still contains molasses, enhances flavor and reduces the harshness of salt. Sugar also hydrogen bonds to water molecules tightly and the water activity is lowered while the meat remains juicy.

As used herein, the term “curing” refers to the process of preserving and flavoring meat by the addition of a curing mixture comprising salt, sugar, and nitrite source. A nitrite source may comprise the combination of celery powder (2-3 wt % of the brine mix), and bacterial culture (0.2-0.3 wt % of the brine mix). In another embodiment, the nitrite source is a nitrite salt. In one embodiment, the brine mix ingredients are combined in a mixing/storage tank. The mixing/storage tank is equipped with an agitator which disperses the dry brine mix with water for at least about 10 minutes prior to the brine mix being dosed into a vacuum tumbler. The diced meat chunks are cured and brined in a vacuum tumbler with brine mix. The addition of brine mix and diced meat chunks may be step-wise or concomitant. Tumbling action in the vacuum tumbler disrupts the tissue structure of the meat to speed the even distribution of brine marination and also increase the salt contact with salt-soluble proteins to effect greater water binding and solubilization of proteins. The vacuum serves to eliminate foam production and to exclude oxygen from the surfaces of the diced meat chunks. Aberle, E D; Forrest, J C; Gerrard, D E; Mills, E W. Principles of Meat Science. Kendall/Hunt Publishing Co. 4th Ed. Iowa:Dubuque, 2001. In the preferred method of the invention the diced meat chunks are cured from at least about 20 minutes to about 60 minutes. More preferably, the diced meat chunks are brined and cured at room temperature for at least about 30 minutes. The excess brine is drained and the cured diced meat chunks are collected and transferred to a mixer.

To formulate all-natural Ruggets, a bacterial culture converts a natural source of nitrate to a nitrite source. In a preferred embodiment, celery powder is used as a natural source of sodium nitrate for the curing solution. Sebranek, J G and Bscus, J N. Journal of Meat Science (2007) 77:136-147. Preferably, the concentration of the aqueous sodium nitrate solution is at least about 2100 ppm. To effect the curing action, nitrate is converted to nitrite by the action of released reductase enzyme of a bacterial lactic acid starter culture. Preferably, the lactic acid starter culture is Staphylococcus Carnosus. Nitrite is then converted to nitric oxide which binds to oxymyoglobin producing nitrosyl-hemochromogen, a cured meat color. Nitrite is also responsible for the development of cured meat flavor and is an inhibitor of Clostridium Botulinum and Listeria Monocytogenes. Furthermore, nitrite acts as a potent antioxidant by reacting with the Fe²⁺ in myoglobin, thus making it unavailable to catalyze lipid oxidation. Aberle, E D; Forrest, J C; Gerrard, D E; Mills, E W. Principles of Meat Science. Kendall/Hunt Publishing Co. 4th Ed. Iowa:Dubuque, 2001. In the preferred method of the invention a natural source of nitrite is provided through the combination of celery powder and culture, however, another embodiment of the present invention would comprise the addition of a nitrite salt such as sodium nitrite.

The second portion of meat is fed into the hopper of a comminution or grinding machine to provide a comminuted or ground meat paste of a desired consistency. As used herein, the term “meat paste,” refers to comminuted or ground meat, wherein the meat does not possess a fibrous morphology and, wherein the meat fibers are pulverized and cut in contrast to the meat chunks. The meat paste may be ground either finely or coarsely as desired. A fine grind size enhances cohesion between materials. In one particular embodiment, the grind size of the second portion of meat is uniform. In an alternative embodiment the second portion of meat is separated and two or more different grind sizes are prepared and later combined.

The comminuted meat paste (75-95 wt % of the ground meat and dry cure mix combination) is combined with dry cure mix (5-25 wt % of the ground meat and dry cure mix combination). In a preferred method of the invention the dry cure mix is weighed and added to the mixer first. The dry cure mix comprises salt, a dry cure flavoring, sugar, a nitrite source, and spices (dry or liquid). In one embodiment of the present invention, the dry cure flavoring is a source of umami. The dry cure flavoring may be selected from miso, steak sauce, shrimp paste, Worcestershire sauce, fermented bean paste, anchovy paste, and soy sauce powder. Preferably, the dry cure flavoring is soy sauce powder. The dry spices may be selected from known spices to provide, Original Recipe (sweet/smoky/mildly spicy), Hawaiian, Korean Barbecue, or Spicy Southwestern flavors. In a preferred embodiment, the dry cure mix comprises salt, soy sauce powder, brown sugar, celery powder, Staphylococcus Carnosus, and Original Recipe flavor spice. The ground meat is then added via a column dumper and both are mixed for at least about 10 minutes.

A meat blend is prepared wherein the cured meat paste (10-50 wt % of the meat blend) is admixed with the cured diced meat chunks (10-50 wt % of the meat blend) and other ingredients (15-60 wt % of the meat blend) in a cylindrical drum mixer with eccentric mixing paddles to ensure uniform blending of the ingredients. In a particular embodiment, some or all of the cured meat paste and/or some or all of the cured diced meat chunks may be substituted with at least one vegetable-based meat substitute. All elements of the blend are mixed for at least about 20 minutes. The produced meat blend is then prepared for forming.

The “other ingredients” may be selected from the group consisting of dried fruit, vegetables, grains, nuts, seeds and vegetable-based meat substitute. The nuts or seeds may be provided to the mixture either whole or sliced or finely divided. The dried fruit may be raisins, cranberries, apricots, cherries, dates, prunes, apple, figs, peach, and mango, etc. Preferably, the dried fruit is raisins, cranberries or a combination thereof. In the preferred method of the invention, nuts may be selected from almonds, hazelnuts, macadamias, chestnuts, walnuts, pecans, cashews, pine nuts, peanuts, and pistachios, etc. Also in the preferred method of the invention, seeds may be selected from sunflower seeds, flax seeds, and pumpkin seeds, etc. Preferably, the nuts and seeds will be unsalted. More preferably, the nuts are almonds, and the seeds are sunflower seeds. The grains may comprise wheat, brown rice, wild rice, white rice, quinoa, rye, sorghum, and barley. The wheat may be selected from bulgur and spelt. Alternatively, the grain may be substituted with bread crumbs, legumes (e.g. peas, beans, lentils, etc.), couscous, and amaranth. In a preferred embodiment, the grain is bulgur. Par-cooked cracked wheat may be weighed and transferred to a soaking vat to hydrate for at least about 1 hour, and then transferred to the mixer. By including unsalted dried nuts/seeds and whole grains the formulation, the overall sodium content is significantly reduced.

The meat blend is fed to the hopper of the depositor. The depositor may be analogized to cookie depositing machines. The machine consists of a hopper for feeding the meat blend. The meat blend is deposited onto smokehouse-ready trays moving passed a set of nozzles, placed in a row, which deposit the meat blend on the tray. Preferably, the tray dimensions are approximately 110×100×2 cm and the deposition is provided by approximately 20 nozzles depositing about 18 times on a tray at an interval of about 1 cm. The trays are then moved forward for stamping of the meat blend deposition.

The stamping machine forms the meat blend deposits into patties by pressing the meat blend from the depositor into a shaped molding roller with multiple cavities to provide the desired shape. The stamping machine is similar to a stamping press used in the metal industry. The meat blend deposit is to be flattened, so instead of the traditional die consisting of bolster plate and ram, the machine has only the ram which can be mechanically driven by an eccentric drive over the meat batter deposit placed on trays moving on the conveyor belt. The ram may consist of a 6×150 cm flat non-stick coated surface facing the meat blend deposit. The tonnage is adjusted to meet the thickness requirement of the formed meat patty. As used herein, the term “patty” refers to a small flat cake of chopped food. In the preferred method of the invention, the thickness requirement is at least about 1 cm. Also in the preferred method, the stamps per minute (SPM) of the stamping machine should be at least about 15.8. The trays containing the patties are then optionally transferred to a cooking machine.

As used herein, the term “cooking” refers to a process whereby products prepared from the meat blend, and the individual components thereof, are heated to an internal temperature such that the products prepared from the meat blend are considered ready for consumption. Cooking comprises at least one of heating, smoking, drying or a combination thereof.

In a preferred embodiment, a smoker is used for smoking and heating the patties. A smoke generator burns woodchips and smoke is transferred via duct and circulated by fans. The woodchips used in the smoking process may be hickory, mesquite, oak, pecan, alder, maple, and fruit-tree woods, such as apple, cherry and plum. Preferably, the woodchips used in the method of the invention are mesquite. The relative humidity is controlled by exhaust and the makeup air entering the smoker. The patties may be initially smoked for a period prior to the drying/heating schedule. Preferably, the patties are smoked for 30 minutes at 49° C., 40% Relative Humidity (RH). The smoked patties may then be subjected to heat treatment in 3 steps. A first schedule is: 1) 45 minutes at 49° C., 40% RH; 2) 90 minutes at 60° C., 30% RH; and 3) 45 minutes at 71° C., 20% RH. A second cooking schedule is: 1) 15 minutes at 49° C., 40% RH; 2) 90 minutes at 60° C., 30% RH; and 3) 45 minutes at 71° C., 20% RH. This process gradually eliminates moisture in the initial phase which allows for more even drying without quickly forming an undesirable dry exterior. As the meat reaches an internal temperature of 71° C. (160° F.), lethality of pathogenic bacteria is ensured. The preferred capacity of the smoke oven is at least about 900 kg patties/batch. In an alternative embodiment, “liquid smoke” may be applied to the patties either before or after the smoking process. If thicker pieces are formed (e.g. into snack bars) then the time/temperature schedule will be less aggressive and the overall drying/cooking process will be lengthened to provide adequate cooking.

The patties are then cooled to ambient temperature. Preferably, the patties are placed on a conveyor belt that passes through a tunnel for gradual reduction in temperature using air blowers for efficient heat transfer.

In a particular embodiment, after cooking, the patties are seasoned by a seasoning applicator. The applicator may provide wet and dry seasoning application. The patties may be lightly sprayed with oil in a first zone. The seasoning is then applied evenly via tumbling action in a second zone. Preferably, the oil is sunflower oil. Seasoning may consist of a dry mix which provides a seasoning of Hawaiian (sweet/smoky/spicy with crystallized pineapple and pork), Korean barbecue (sesame seed, crystallized ginger, scallion), Jamaican Jerk (chicken, jerk spice), and spicy southwestern seasoning. The ordinary artisan would recognize that there is a wide variety of commercially available dry and wet seasoning mixes and the list provided herein is only a small sampling of such seasonings.

The patties are deposited into a packaging system which protects the Ruggets against oxidation. Preferably, the packaging system for the Ruggets not only provides an oxygen barrier but also contains an oxygen scavenger. The art is replete with suitable packaging systems which may or may not contain an oxygen scavenger either as part of the container or as an addition thereto. Therefore, the skilled artisan would have no difficulty in selecting a suitable packaging system for the Ruggets in order to prevent oxidation. In one embodiment of the present invention, the patties are deposited into preformed high barrier linear low density polyethylene (LLDPE) film packages lined with ethylene vinyl alcohol (EVOH) with subsequent nitrogen flushing. The packaging may be also provided with an oxygen scavenger to ensure protection against lipid oxidation. The term “packaging” as used herein comprises at least one of primary packaging, secondary packaging, tertiary packaging or a combination thereof. Primary packaging comprises discharging the patties from a large reservoir hopper above an automatic weighing system where the patties are portioned and dropped into a discharge hopper. From the discharge hopper the patties are deposited into a suitable container along with an oxygen scavenger sachet. The containers are collected and sealed. The sealed containers are then collected. Secondary packaging involves collecting the containers in a secondary carton that functions as a display box for store shelves. Tertiary packaging comprises collecting the secondary cartons on to a standard pallet suitable for shipment.

Appropriate steps should be taken to prevent oxidation of polyunsaturated fatty acids (PUFA), which may lead to the development of rancid off-flavor notes in the finished product. The fraction of PUFA to total fat content is 44% for beef, 88% for almonds, and 85% for sunflower seeds. In the preferred method of the invention, a package that is an excellent barrier to oxygen and moisture, including an oxygen scavenging sachet, is utilized because the rate of lipid oxidation is dependent on the presence of oxygen. Since the preferred packaging incorporates multiple hurdle technology (high osmotic strength due to salt and sugar, nitrite, minimal oxygen concentration, and A_{W} less than about 0.75) microbial growth does not contribute appreciably to off-flavor notes in Ruggets. The shelf-life of Ruggets is at least about 6 months. Preferably, the shelf-life of Ruggets is about 6 to 12 months

The following examples are provided to describe the invention in further detail. These examples are provided for illustrative purposes only and are not intended to limit the invention in any way.

### Example 1

### Representative Process for Making Ruggets

### Brined Meat Cubes

Step 1: Prepare brine mixture (Table 1) by combining water (60%), salt (4.8%), brown sugar (27%), soy sauce powder (4.8%), celery juice powder (2.5%), and bacterial culture, Staphylococcus Carnosus (0.25%) at room temperature. Mix well to dissolve all dry ingredients.

TABLE 1

| Brine Mixture: | True wt. (g) | wt. % | true % | per 32 g |
|---|---|---|---|---|
| Water | 19.39 | 0.61 | 0.57 | 18.27 |
| Salt | 1.55 | 0.05 | 0.05 | 1.46 |
| Brown sugar | 8.73 | 0.27 | 0.26 | 8.22 |
| Soy powder | 1.55 | 0.05 | 0.05 | 1.46 |
| Celery | 2.50 | 0.02 | 0.07 | 2.35 |
| Culture | 0.25 | <0.01 | 0.01 | 0.24 |
| | 33.97 | 1.00 | 1.00 | 32.00 |

Step 2: Combine cubed lean beef top round (1 cm³) (89%) with brine mixture from Step 1 (11%); mix well so that all surfaces of meat are in contact with the brine mixture from Step 1. Transfer mixture to a vacuum tumbler and let cure at room temperature for 30 minutes. After this period, drain excessive brine.

### Dry Cure Mix

Step 3: Prepare dry cure mix (Table 2) by combining salt (26%), soy sauce powder (21%), brown sugar (27%), celery juice powder (8%), bacterial culture (Staphylococcus Carnosus) (0.8%), and dry spices (16%), blending until all ingredients are well dispersed.

TABLE 2

| Dry Cure: | True wt. (g) | wt. % | per 32 g |
|---|---|---|---|
| Salt | 8.31 | 0.27 | 8.57 |
| Soy powder | 6.65 | 0.21 | 6.86 |
| Sugar | 8.31 | 0.27 | 8.57 |
| Celery | 2.50 | 0.08 | 2.58 |
| Culture | 0.25 | 0.01 | 0.26 |
| Flavor | 5.00 | 0.16 | 5.16 |
| | 31.03 | 1.00 | 32.00 |

### Soaked Bulgur

Step 4: Combine bulgur (30%) with water (70%) and soak at room temperature for 1 hour, or until soft. Drain excess water.

### Meat/Inclusion Mixture

Step 5: Combine coarsely ground (7 mm) lean beef from top round (89%) with Dry Cure Mix from Step 3 (11%). Mix well to evenly disperse all ingredients.

Step 6: Combine ground beef mixture of Step 5 (30%) with brined meat cubes of Step 2 (30%), sweetened cranberry pieces, (0.5 cm) (8.2%), golden raisin pieces (0.5 cm) (8.2%), toasted almond pieces (0.75 cm) (2.8%), whole sunflower seeds (2.8%), and Soaked Bulgur from Step 4 (6.9%). Mix well to ensure even dispersal of all ingredients (Tables 3 and 4). Total mixing time is approximately 20 minutes, over the course of mixing the curing process of the ground meat occurs.

TABLE 3

| Composition of meat/inclusion | | |
|---|---|---|
| mix (pre-drying): | wt. (g) | wt. % |
| Water | 105.267 | 0.115 |
| Salt | 10.035 | 0.011 |
| Brown sugar | 16.794 | 0.018 |
| Soy powder | 8.321 | 0.009 |
| Celery juice powder | 4.933 | 0.005 |
| Culture | 0.493 | 0.001 |
| Meat cubes, top inside round, denuded | 250.000 | 0.274 |
| Flavor | 5.156 | 0.006 |
| Ground meat, top inside round, denuded | 250.000 | 0.274 |
| Cranberry, sweetened, dried | 75.000 | 0.082 |
| Raisin | 75.000 | 0.082 |
| Almond, toasted, sliced | 25.000 | 0.027 |
| Sunflower, toasted, whole | 25.000 | 0.027 |
| Bulgur, par cooked, dried | 63.000 | 0.069 |
| | 914.000 | 1.000 |

TABLE 4

| Overall: | | wt. (g) |
|---|---|---|
| Brine: | Water | 18.27 |
| | Salt | 1.46 |
| | Brown sugar | 8.22 |
| | Soy powder | 1.46 |
| | Celery | 2.35 |
| | Culture | 0.24 |
| Cubes: | Meat cubes | 250.00 |
| Dry Mix: | Salt | 8.57 |
| | Soy powder | 6.86 |
| | Sugar | 8.57 |
| | Celery | 2.58 |
| | Culture | 0.26 |
| | Flavor | 5.16 |
| Ground: | Ground meat | 250.00 |
| Garnish: | Cranberry | 75.00 |
| | Raisin | 75.00 |
| | Almond | 25.00 |
| | Sunflower | 25.00 |
| Wheat: | Bulgur | 63.00 |
| | Water | 87.00 |
| | | 914.00 |

### Forming/Smoking/Drying

Step 7: Use approximately 12.5 g of Meat/Inclusion Mixture from Step 6 to form single patties of approximately 2×2×0.75 cm dimensions. Place patties on smokehouse-ready perforated trays in a single layer at 1 cm separation intervals.

Step 8: Smoke the patties using mesquite wood smoke for 30 minutes at 49° C., 40% RH.

Step 9: Dry the meat patties without smoke using the following schedule: 1) 15 minutes at 49° C., 40% RH; 2) 90 minutes at 60° C., 30% RH; and 3) 45 minutes at 71° C., 20% RH. The smoked and dried meat patties (Table 5) are allowed to cool to room temperature then vacuum packaged, 9 pieces per salable unit, with an oxygen scavenger sachet included.

TABLE 5

| Mixture: | wt. (g) | wt. % |
|---|---|---|
| Brine (see recipe) | 32.00 | 0.05 |
| Meat cubes | 250.00 | 0.35 |
| Dry cure (see recipe) | 24.00 | 0.03 |
| Ground meat | 250.00 | 0.35 |
| Cranberry | 75.00 | 0.04 |
| Raisin | 75.00 | 0.04 |
| Almond | 25.00 | 0.04 |
| Sunflower | 25.00 | 0.04 |
| Bulgur | 63.00 | 0.07 |
| Water | 87.00 | — |
| Total wet weight | 906.00 | 1.00 |
| Total dry weight (less water loss) | 169.39 | |
| Final weight | 736.61 | |
| Percent of initial | 0.81 | |

The nutritional values for a single serving of Ruggets (30 g) are provided in Table 6.

TABLE 6
Nutritional Content of a Ruggets Serving (30 g)

| | |
|---|---|
| Calories | 80 |
| Calories from Fat | 25 |

| | Amount (g) | % Daily Value |
|---|---|---|
| Total Fat | 3 | 4 |
| Saturated Fat | 0.5 | 3 |
| Trans Fat | 0 | — |
| Cholesterol | 0.02 | 7 |
| Sodium | 0.35 | 15 |
| Total Carbohydrate | 6 | 2 |
| Dietary Fiber | <1 | 4 |
| Sugars | 3 | — |
| Protein | 9 | — |
| Vitamin A | | 0 |
| Vitamin C | | 0 |
| Calcium | | 0 |
| Iron | | 6 |

### Example 2

### Sensory and Focus Group Testing of Ruggets

A preference test was conducted against Jack Link's Beef Steak Nugget, a leading brand of dried meat snack (n=49). Of the respondents who consume beef jerky at least weekly, Ruggets scored at least as well as the competitor in terms of texture, flavor, color, aroma, and overall acceptability. Following the first preference test, a mini-focus group composed of 5 male panelists ranging from 21-55 years old to gain insight into the target market demand. All subjects indicated greater purchase intent over other dried meat snacks, citing Ruggets' ability to address the undesirable issue of tough texture, high sodium, and high price. Following the panelists recommendation, a second panel was assembled (n=29), from which there was no statistical difference between Ruggets and Jack Link's® Beef Steak Nuggets in terms of aroma, texture, and flavor. However, 55% of the panelists showed purchase intent of Ruggets.

A number of non-patent documents are cited in the foregoing specification in order to describe the state of the art to which this invention pertains. The entire disclosure of each of the cited documents is incorporated by reference herein.

While various embodiments of the present invention have been described and/or exemplified above, numerous other embodiments will be apparent to those skilled in the art upon review of the foregoing disclosure. The present invention is, therefore, not limited to the particular embodiments described and/or exemplified, but is capable of considerable variation and modification without departure from the scope of the appended claims. Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All compositions, products, and methods of use thereof that embody the present invention can, in alternate embodiments, be more specifically defined by any of the transitional terms “comprising”, “consisting essentially of” and “consisting of”.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed, then “less than or equal to 10” is disclosed, as well as “greater than or equal to 10” is also disclosed. It is also understood that throughout the application data is provided in a number of different formats and that these data represent end points and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

What is claimed is:

1. A process for preparing a meat snack comprising the steps of:
a. providing a plurality of meat chunks comprising a first cure mix, wherein the plurality of meat chunks is substantially fibrous;
b. providing a meat paste comprising a second cure mix, said first and second cure mix being the same or different, and wherein the meat paste is not substantially fibrous;
c. combining at least one of nuts, seeds, fruit, the plurality of meat chunks and the meat paste into a predominantly meat blend, wherein the meat paste functions as a binding agent;
d. forming a meat patty from the meat blend; and
e. cooking the meat patty.

2. The process of claim 1, wherein the step of cooking comprises smoking the meat patty.

3. The process of claim 1, wherein the step of cooking comprises drying the meat patty.

4. The process of claim 1, further comprising a step of packaging the meat patty.

5. The process of claim 1, wherein meat is selected from the group consisting of beef, buffalo, chicken, venison, veal, pork, lamb, fish, shellfish, turkey, and vegetable based meat substitute.

6. The process of claim 5, wherein the vegetable based meat substitute is selected from the group consisting of mushrooms, legumes, pulses, and soy.

7. The process of claim 1, wherein the meat is beef.

8. The process of claim 1, wherein the first cure mix comprises a brine mix.

9. The process of claim 8, wherein the brine mix comprises water, salt, sugar, a nitrite source and a flavoring.

10. The process of claim 9, wherein the sugar is selected from the group consisting of white sugar and brown sugar.

11. The process of claim 10, wherein the sugar is brown sugar.

12. The process of claim 9, wherein the flavoring comprises a source of umami.

13. The process of claim 12, wherein the source of umami is selected from the group consisting of miso, steak sauce, shrimp paste, Worcestershire sauce, fermented bean paste, anchovy paste and soy sauce powder.

14. The process of claim 9, the flavoring is soy sauce powder.

15. The process of claim 9, wherein the nitrite source comprises celery powder and Staphylococcus Carnosus.

16. The process of claim 9, wherein the nitrite source is sodium nitrite.

17. The process of claim 1, wherein the second cure mix comprises salt, a flavoring, sugar and a nitrite source.

18. The process of claim 1, wherein the meat blend comprises at least about 10-50 wt % meat paste and at least about 10-50 wt % meat chunks.

19. The process of claim 1, wherein the meat blend further comprises a vegetable, a grain or a combination thereof.

20. The process of claim 19, wherein the grain is selected from the group consisting of wheat, brown rice, wild rice, white rice, quinoa, rye, sorghum, barley or a combination thereof.

21. The process of claim 20, wherein the wheat comprises bulgur or spelt.

22. The process of claim 1, wherein the grain is bulgur.

23. The process of claim 1, wherein fruit is selected from the group consisting of raisins, cranberries, apricots, cherries, dates, prunes, apple, figs, peach, mango and a combination thereof.

24. The process of claim 1, wherein the fruit comprises raisins, cranberries or a combination thereof.

25. The process of claim 1, wherein nuts are selected from the group consisting of almonds, hazelnuts, macadamias, chestnuts, walnuts, pecans, cashews, pine nuts, peanuts, pistachios, or a combination thereof.

26. The process of claim 1, wherein seeds are selected from the group consisting of sunflower seeds, flax seeds, pumpkin seeds or a combination thereof.

27. A process for preparing a dried meat snack comprising the steps of:
a. separating a quantity of meat into a first portion and a second portion;
b. subdividing the first portion into a plurality of meat chunks, wherein the plurality of meat chunks is substantially fibrous;
c. comminuting the second portion into a meat paste, wherein the meat paste is not substantially fibrous;
d. first curing the plurality of meat chunks, wherein first curing comprises applying a first cure mix to the plurality of meat chunks;
e. second curing the meat paste, wherein second curing comprises applying a second cure mix to the meat paste;
f. combining at least one of nuts, seeds, fruit, the plurality of meat chunks and the meat paste into a meat blend, wherein the meat paste functions as a binding agent;
g. forming a meat patty from the meat blend; and
h. cooking the meat patty.

28. The process of claim 27, wherein the first portion is at least about 40-60 wt % of the quantity of meat.

29. The process of claim 27, wherein the second portion is at least about 40-60 wt % of the quantity of meat.

30. A product prepared from the process of claim 1.

31. A product prepared from the process of claim 27.

32. An article of manufacture in the form of a patty comprising a plurality of meat chunks, a meat paste, at least one of nuts, fruit, seeds and grain, in a sealed package.

33. The product of claim 32, wherein the package material is oxygen impervious.

34. The product of claim 32, wherein the package material is a polymer film.

35. The product of claim 32, wherein an oxygen scavenger is included in said package.
